(19) United States
(12) Patent Application Publication
(10) Pub. No.: US 2019/0384106 A1
(43) Pub. Date: Dec. 19, 2019

(54) DISPLAY MODULE AND DISPLAY DEVICE

(71) Applicant: Wuhan China Star Optoelectronics Technology Co., Ltd., Wuhan, Hubei (CN)

(72) Inventors: Chao LIANG, Shenzhen, Guangdong (CN); Mei HAN, Shenzhen, Guangdong (CN); Gege ZHOU, Shenzhen, Guangdong (CN)

(21) Appl. No.: 15/746,728

(22) PCT Filed: Dec. 18, 2017
(86) PCT No.: PCT/CN2017/116904

§ 371 Date: Oct. 26, 2018

(30) Foreign Application Priority Data
Nov. 14, 2017 (CN) 201711135551.9

(51) Int. Cl. G02F 1/1335; F21V 8/00

(52) U.S. Cl. CPC G02F 1/133528; G02F 2202/28; G02B 6/0055; G02B 6/0053

(57) ABSTRACT

A display module and a display device are provided. The display module comprises a liquid crystal display panel, a backlight module, a single-sided adhesive layer, the liquid crystal display panel is positioned on the backlight module, the backlight module comprising a top side and a bottom side opposite positioned on the top side, and four lateral sides located between the top side and the bottom side, the single-sided adhesive layer is adhesive and covering surface of the bottom side and surface of the four lateral sides. Using the display module could narrow the frame of display module, and achieves to full screen. It also could let thickness of the display module become thinner and lighter.

### RELATED APPLICATIONS

The present application is a National Phase of International Application Number PCT/CN2017/116904, filed Dec. 18, 2017, and claims the priority of China Application No. 201711135551.9, filed Nov. 14, 2017.

### FIELD OF THE DISCLOSURE

The disclosure relates to a liquid crystal display technical field, and more particularly to a display module and a display device.

### BACKGROUND

With popularization of personal terminal products such as cell phone, tablet, the full screen has already become the standard specification of the cell phone currently. The requirement of cell phone frame is become narrower, and the most reason to decide frame of cell phone is structure of display module. Therefore, size of frame of the display module as small as possible.

In the existing technology, narrow frame of display module usually is by using lateral frame and sealant compositing to be inner-outside layers on the four lateral sides of back substrate: edge frame is fixing the backlight module and LCD after assembling the lateral frame, and blocking around the backlight module. However, this kind design is difficult to narrow the frame, because of the factors such as sealant module process, size of lateral frame, membrane materials for package.

### SUMMARY

The purpose of this disclosure is provides a display module has small size frame. An objective of the disclosure is achieved by following embodiments. In particular, a display module, comprising a liquid crystal display panel, a backlight module, a single-sided adhesive layer, the liquid crystal display panel is positioned on the backlight module, the backlight module comprising a top side and a bottom side opposite positioned on the top side, and four lateral sides located between the top side and the bottom side, the single-sided adhesive layer is adhering and covering surface of the bottom side and surfaces of the four lateral sides.

In an embodiment, thickness of the single-sided adhesive layer is 0.01-0.05 mm, and color of the single-sided adhesive layer is black.

In an embodiment, the display module further comprises a first adhesive layer, the first adhesive layer is for adhering the liquid crystal display panel on the top side.

In an embodiment, thickness of the first adhesive layer is 0.02-0.05 mm.

In an embodiment, the liquid crystal display panel comprises an upper polarizer, a first panel, a lower polarizer, the first panel is positioned between the upper polarizer and the lower polarizer, the lower polarizer is adhering to the first adhesive layer.

In an embodiment, the liquid crystal display panel comprises a second panel, the second panel is positioned between the first panel and the lower polarizer, the second panel is adhering to the first adhesive layer by an optical adhesive layer.

In an embodiment, an accommodation space is formed by the single-sided adhesive layers which covering surface of the bottom side and surfaces of the four lateral sides, the backlight module further comprises a reflective membrane, a light guide plate, a complex prism film are sequentially stacked, the bottom side is the reflective membrane, the top side is the complex prism film, and the reflective membrane, the light guide plate and the complex prism film are positioned in the accommodation space.

In an embodiment, the lower polarizer and the complex prism film are adhering by the first adhesive layer.

In an embodiment, the display module further comprises a second adhesive layer, the complex prism film and the light guide plate are adhering by the second adhesive layer.

According to another aspect of the disclosure, the disclosure further provides a display device. The display device includes a display module as described above.

The one aspect of the disclosure provides a display module, the single-sided adhesive layer is adhering surface of the bottom side and surfaces of four lateral sides. The disclosure is envelopes the entire backlight module by single-sided adhesive layer, not only providing function of fixing backlight module, the single-sided adhesive layer also could prevents light leakage. Because of thickness of the single-sided adhesive layer is less than thickness of compositing the lateral sides and sealant to be inner-outside two layers in traditional technology, the display module frame of this disclosure is smaller than the existing technology, it achieves to narrow frame of display module. And using the single-sided adhesive layer replaces to the lateral frame and sealant of traditional one could also let display module become thinner, lighter. Another aspect of the disclosure provides a display device, the size of frame of the display device is obviously smaller than the present technology, and gradually achieves to full screen. It also could achieve to thinner, lighter the display device.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is an inner structural cross-section view of a display panel module to an embodiment of the disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

The disclosure will be further described in detail with reference to accompanying drawings and preferred embodiments as follows.

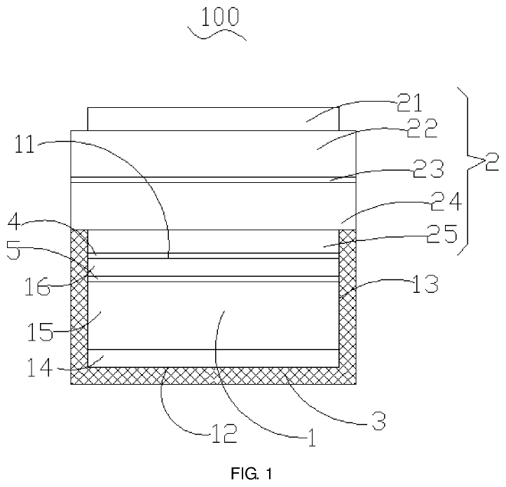

Please refer to FIG. 1. The first aspect provided a display module 100, comprising a liquid crystal display panel 2, a backlight module 1, a single-sided adhesive layer 3. The liquid crystal display panel 2 is positioned on the backlight module 1. The backlight module 1 comprising a top side 11 and a bottom side 12 is opposite positioned on the top side 11, and four lateral sides 13 are located between the top side 11 and the bottom side 12. The single-sided adhesive layer 3 is adhering and covering surface of the bottom side 12 and surfaces of the four lateral sides 13.

The single-sided adhesive layer 3 is adhering and covering surface of the bottom side 12 and surfaces of the four lateral sides 13. A preferably embodiment which is enveloping bottom and periphery of the backlight module 1 by the single-sided adhesive layer 3, and forming an accommodation space. Firstly, fixing the backlight module 1 to the accommodation space that is providing fix and support function to the backlight module 1. Secondly, it could prevent light leakage from edge while fixing the backlight module 1 by the single-sided adhesive layer 3. Because thickness of the single-sided adhesive layer 3 is less than thickness of using the lateral frame and sealant compositing to be inner and outside layer of the traditional one, a frame of the display module 100 of the embodiment in this disclosure is less than a frame of the display module 100 of the existing technology. It could achieve to purpose of narrow frame of the display module. And according to use the single-sided adhesive layer 3 replaces to the lateral frame and sealant of the traditional one, thickness of the display module 100 will thinner than the display module 100 of existing technology, and weight is lighter than the existing technology one. Therefore, the single-sided adhesive layer 3 will let the display module 100 more thin and light.

The thickness of the single-sided adhesive layer is 0.01-0.05 mm, and color of the single-sided adhesive layer is black. In the existing technology, thickness of the lateral frame generally is 0.1-0.2 mm, thickness of the sealant generally is 0.1-0.2 mm. Therefore, thickness of the display module frame caused by the single-sided adhesive layer which is less than the thickness of using the lateral frame and sealant compositing to inner and outside layer of the traditional one.

The thickness of the first adhesive layer is 0.02-0.05 mm. The material of the first adhesive layer is OCA gel. In the traditional lateral frame structure will coating optical cement on a side of lateral frame which far away the substrate for adhering the liquid crystal display panel 2. It will form a space between the liquid crystal display panel 2 and the backlight module 1, and the first adhesive layer could eliminate the space and enhance property of the display module.

The display module 100 further comprises a first adhesive layer 4, the first adhesive layer 4 is for adhering the liquid crystal display panel 2 on the top side 11. Using the first adhesive layer 4 to adhere the liquid crystal display panel 2 on the top side 11, which could effectively fixing the liquid crystal display panel 2 and the backlight module 1 together.

The liquid crystal display panel 2 comprises an upper polarizer 21, a first panel 22, a lower polarizer 25. The first panel 22 is positioned between the upper polarizer 21 and the lower polarizer 25, the lower polarizer 25 is adhering to the first adhesive layer 4.

The liquid crystal display panel 2 comprises a second panel 24. The second panel 24 is positioned between the first panel 22 and the lower polarizer 25. The second panel 24 is adhering to the first adhesive layer 22 by an optical adhesive layer 23. In this preferably embodiment, the first adhesive layer 22 is color filter, the second panel 24 is thin film transistor.

An accommodation space is formed by the single-sided adhesive layers 3 which enveloping surface of the bottom side 12 and surfaces of the four lateral sides 13. The backlight module 1 further comprises a reflective membrane 14, a light guide plate 15, a complex prism film 16 are sequentially stacked, the bottom side 12 is the reflective membrane 14, the top side 11 is the complex prism film 16, and the reflective membrane 14, the light guide plate 15 and the complex prism film 16 are positioned in the accommodation space.

the lower polarizer 25 and the complex prism film 16 are adhering by the first adhesive layer 4, which is fixing the liquid crystal display panel 2 and the backlight module 1 together.

The display module 1 further comprises a second adhesive layer 5, the complex prism film 16 and the light guide plate 15 are adhering by the second adhesive layer 5. It could enhance light homogenization and brightness, and also could prevent inner shift of the display module 1.

The second aspect of this disclosure provides a display device, the display device comprises the display module provided by the first aspect of this invention. Comparing with the existing technology, this display device is obviously narrow size of frame, and gradually achieves effect of full screen. It also achieve to thinner, lighter display device.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A display module, comprising a liquid crystal display panel, a backlight module, a single-sided adhesive layer, the liquid crystal display panel is positioned on the backlight module, the backlight module comprising a top side and a bottom side opposite positioned on the top side, and four lateral sides located between the top side and the bottom side, the single-sided adhesive layer is adhering and covering surface of the bottom side and surface of the four lateral sides.

2. The display module according to claim 1, wherein thickness of the single-sided adhesive layer is 0.01-0.05 mm, and color of the single-sided adhesive layer is black.

3. The display module according to claim 2, wherein the display module further comprises a first adhesive layer, the first adhesive layer is used for pasting the liquid crystal display panel on the top side.

4. The display module according to claim 3, wherein thickness of the first adhesive layer is 0.02-0.05 mm.

5. The display module according to claim 3, wherein the liquid crystal display panel comprises an upper polarizer, a first panel, a lower polarizer, the first panel is positioned between the upper polarizer and the lower polarizer, the lower polarizer is adhering to the first adhesive layer.

6. The display module according to claim 5, wherein the liquid crystal display panel comprises a second panel, the second panel is positioned between the first panel and the lower polarizer, the second panel is adhering to the first adhesive layer by an optical adhesive layer.

7. The display module according to claim 6, wherein an accommodation space is formed by the single-sided adhesive layers which covering surface of the bottom side and surfaces of the four lateral sides, the backlight module further comprises a reflective membrane, a light guide plate, a complex prism film are sequentially stacked, the bottom side is the reflective membrane, the top side is the complex prism film, and the reflective membrane, the light guide plate and the complex prism film are positioned in the accommodation space.

8. The display module according to claim 7, wherein the lower polarizer and the complex prism film are adhering by the first adhesive layer.

9. The display module according to claim 8, wherein the display module further comprises a second adhesive layer, the complex prism film and the light guide plate are adhering by the second adhesive layer.

10. A display device, comprises a display module, the display module comprising a liquid crystal display panel, a backlight module, a single-sided adhesive layer, the liquid crystal display panel is positioned on the backlight module, the backlight module comprising a top side and a bottom side opposite positioned on the top side, and four lateral sides located between the top side and the bottom side, the single-sided adhesive layer is adhering and covering surface of the bottom side and surfaces of the four lateral sides.

11. The display device according to claim 10, wherein thickness of the single-sided adhesive layer is 0.01-0.05 mm, and color of the single-sided adhesive layer is black.

12. The display device according to claim 11, wherein the display device further comprises a first adhesive layer, the first adhesive layer is used for pasting the liquid crystal display panel on the top side.

13. The display device according to claim 12, wherein thickness of the first adhesive layer is 0.02-0.05 mm.

14. The display device according to claim 12, wherein the liquid crystal display panel comprises an upper polarizer, a first panel, a lower polarizer, the first panel is positioned between the upper polarizer and the lower polarizer, the lower polarizer is adhering to the first adhesive layer.

15. The display device according to claim 14, wherein the liquid crystal display panel comprises a second panel, the second panel is positioned between the first panel and the lower polarizer, the second panel is adhering to the first adhesive layer by an optical adhesive layer.

16. The display device according to claim 15, wherein an accommodation space is formed by the single-sided adhesive layers which covering surface of the bottom side and surfaces of the four lateral sides, the backlight module further comprises a reflective membrane, a light guide plate, a complex prism film are sequentially stacked, the bottom side is the reflective membrane, the top side is the complex prism film, and the reflective membrane, the light guide plate and the complex prism film are positioned in the accommodation space.

17. The display device according to claim 16, wherein the lower polarizer and the complex prism film are adhering by the first adhesive layer.

18. The display device according to claim 17, wherein the display device further comprises a second adhesive layer, the complex prism film and the light guide plate are adhering by the second adhesive layer.
